(19) United States
(12) Patent Application Publication
(10) Pub. No.: US 2006/0227163 A1
(43) Pub. Date: Oct. 12, 2006

(54) Roll brushing apparatus, inkjet head cleaning system including the same and method of using thereof

(75) Inventors: Seong-Gyu Kwon, Gyeonggi-do (KR); Yoon-Ho Kang, Gyeonggi-do (KR); Jang-Sub Kim, Gyeonggi-do (KR); Byoung-Joo Kim, Gyeonggi-do (KR)

Correspondence Address: David W. Heid;MacPHERSON KWOK CHEN & HEID LLP, Suite 226, 1762 Technology Drive, San Jose, CA, 95110, US

(73) Assignee: Samsung Electronics Co., Ltd.

(21) Appl. No.: 11/393,167

(22) Filed: Mar. 29, 2006

(30) Foreign Application Priority Data
Apr. 7, 2005 (KR) 10-2005-0028875

(51) Int. Cl. B41J 2/165

(52) U.S. Cl. 347/33

(57) ABSTRACT

A roll brushing apparatus for cleaning an inkjet head including a case, a roll brush connected to the case through an axle, and a roll brush cover encompassing a portion of the roll brush. During cleaning the inkjet head, the roll brush is rotated at approximately less than 50 RPM to prevent contaminants from flying off the roll brush. After cleaning the inkjet head, the roll brush cover is moved between the roll brush and the inkjet head to prevent contaminants coming off the roll brush from contaminating the inkjet head. The rotational speed of the brush is also increased to more than 50 RPM to remove contaminants on the roll brush. A solvent may also be sprayed onto the roll brush to aid in contaminant removal after cleaning the inkjet head.

### CROSS-REFERENCE TO RELATED APPLICATION

This application claims priority to Korean Patent Application No. 2005-028875, filed on Apr. 7, 2005, the disclosure of which is hereby incorporated herein by reference in its entirety for all purposes.

### BACKGROUND

1. Field of the Invention

The present invention relates generally to a roll brushing apparatus, an inkjet head cleaning system including the same, and a method of cleaning an inkjet head.

2. Description of Related Art

Conventionally, an inkjet printing system can be used to form organic layers of organic light emitting displays (OLEDs) including organic light emitting layers, color filters, and alignment films of liquid crystal displays (LCDs).

The inkjet printing system has an inkjet head including a plurality of nozzles, through which a volume of ink is dispensed to a portion of area of a substrate to form patterns of the organic layers, the color filters, and the alignment films. However, when the nozzles of the inkjet head are contaminated, ink dispersion from the nozzles can become less linear and result in larger ink dispersions after a volume of ink is dispensed, which can lead to dispensing ink to a neighboring area other than the desired area. Also, a heavy contamination of a nozzle may result in blockage of the nozzle and cause ink to accumulate in the nozzle, which can prevent the nozzle from properly dispensing ink. To reduce these problems, the present invention provides a roll brushing apparatus, an inkjet head cleaning system including the same, and a method of using the inkjet head cleaning system without damaging the inkjet head.

### SUMMARY

According to one aspect of the present invention, a roll brushing apparatus, an inkjet cleaning system including the roll brushing apparatus, and a method of cleaning an inkjet head are provided.

In an exemplary embodiment of a roll brushing apparatus according to the present invention, the roll brushing apparatus includes a case, a roll brush having an axle connected to the case, and a roll brush cover encompassing a portion of the roll brush. The roll brush rotates to clean a lower surface of the inkjet head.

During cleaning of the lower surface of the inkjet head, the roll brush cover is disposed against the inkjet head and the roll brush rotates at lower than 50 RPM in one embodiment. After cleaning the lower surface of the inkjet head, the roll brush increases its rotational speed, such as higher than 50 RPM.

The roll brush apparatus further includes a solvent supplier under the roll brush inside the case. In one embodiment, the solvent supplier is offset from the center of the lower surface of the inkjet head so that the solvent supplier dispenses solvent toward the roll brush at an angle. The roll brush cover encompasses half of the circumference of the roll brush and can be rotated to cover the top or bottom half of the roll brush.

According to an embodiment of this invention, the inkjet head cleaning system includes a solvent shower spraying a solvent toward the lower surface of the inkjet head for dissolving contaminants in and on the inkjet head, such as in and around the nozzles, a suction apparatus, such as a vacuum, apart from the solvent shower to suck the dissolved contaminants from the inkjet head, and an air blower apart from the suction apparatus to blow air toward the lower surface of the inkjet head for drying the solvent.

The inkjet head cleaning system further comprises a roll brush apparatus to rotate in contact with the lower surface of the inkjet head and remove contaminants from the lower surface of the inkjet head. In one embodiment, the roll brush apparatus includes a case, a roll brush having an axle connected to the case, a roll brush cover encompassing a portion of the circumference of the roll brush, and a solvent supplier, as discussed above.

In an exemplary method of cleaning an inkjet head according to the present invention, the method includes discharging ink from inside the inkjet head, spraying a solvent toward a lower surface of the inkjet head to dissolve contaminants on and around the surface, sucking the dissolved contaminants from the inkjet head, blowing air toward to the lower surface of the inkjet head to dry the solvent, rotating a roll brush cover underneath the roll brush, and rotating the roll brush along the lower surface of the inkjet head at lower than 50 RPM to remove remaining hardened contaminants.

The method further comprises moving the roll brush cover over the roll brush, either before or after cleaning the lower surface of the inkjet head, and rotating the roll brush at higher than 50 RPM.

In one embodiment, solvent is dispensed at an angle toward the roll brush for removing contaminants from the roll brush.

### BRIEF DESCRIPTION OF THE DRAWINGS

The features of the present invention will become more apparent to those of ordinary skill in the art by describing in detail exemplary embodiments thereof with reference to the attached drawings, in which:

FIG. 1 is a perspective view showing a plurality of inkjet head units to form color filters according to an embodiment of the present invention;

FIG. 2 is a plan view illustrating an inkjet process of forming color filters by using a plurality of inkjet head units;

FIG. 3 is a perspective view of one of the inkjet head units shown in FIG. 2;

FIG. 4 is a plan view of the inkjet head unit shown in FIG. 3;

FIG. 5 is a view showing a process of dispensing ink to form color filters by using an inkjet head of FIG. 1 according to an embodiment of the present invention;

FIG. 6 is a systematically cross-sectional view of an inkjet cleaning system according to an embodiment of the present invention;

FIG. 7 is a perspective view of a roll brushing apparatus to clean the lower surface of an inkjet head according to one embodiment;

FIG. 8 is a perspective view of a roll brushing apparatus with a solvent dispenser to spray solvent for removing contaminants from the roll brush; and

FIGS. 9A and 9B are a front perspective view and a back perspective view of a roll brush and a roll brush cover, respectively.

Use of the same reference symbols in different figures indicates similar or identical items.

### DETAILED DESCRIPTION

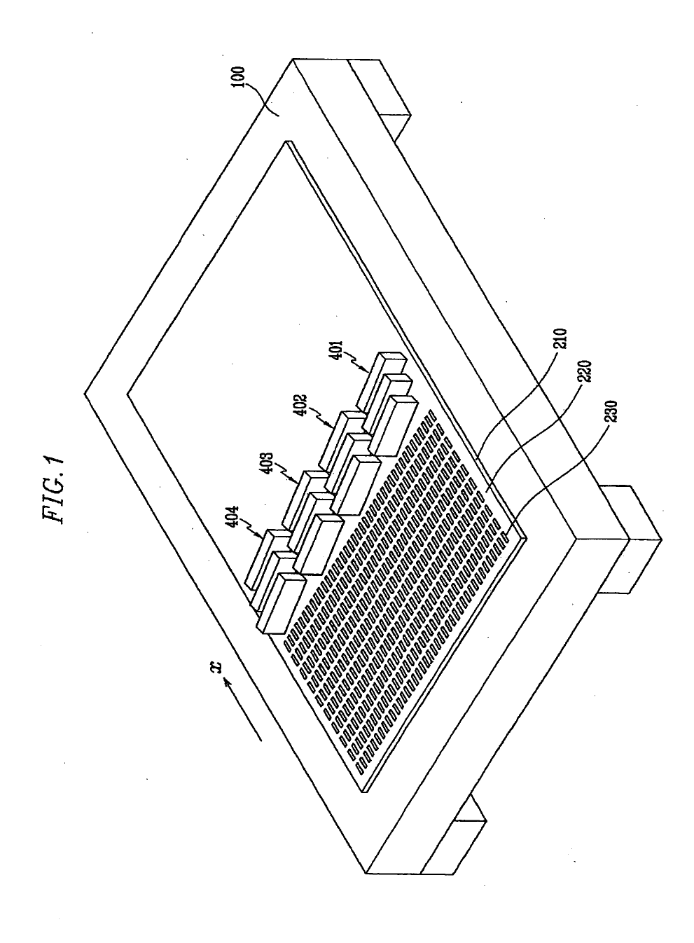

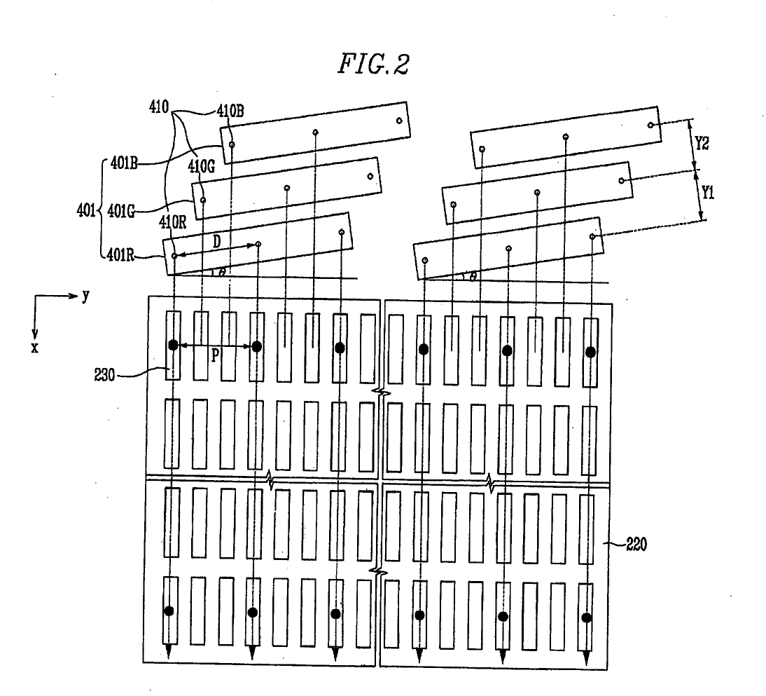

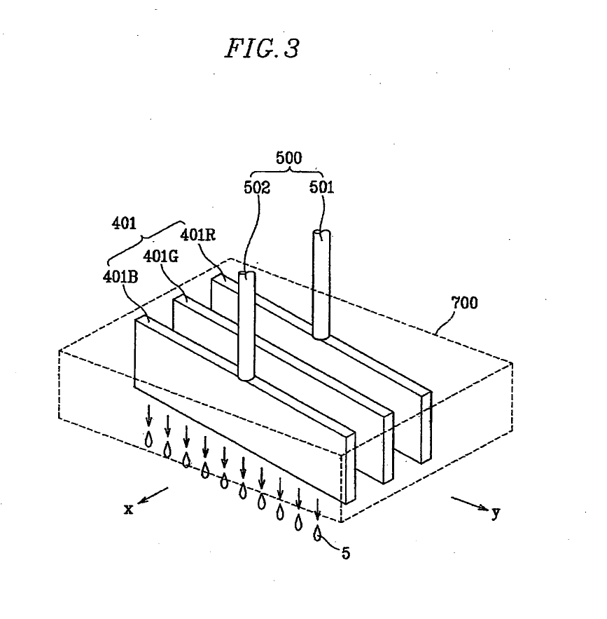

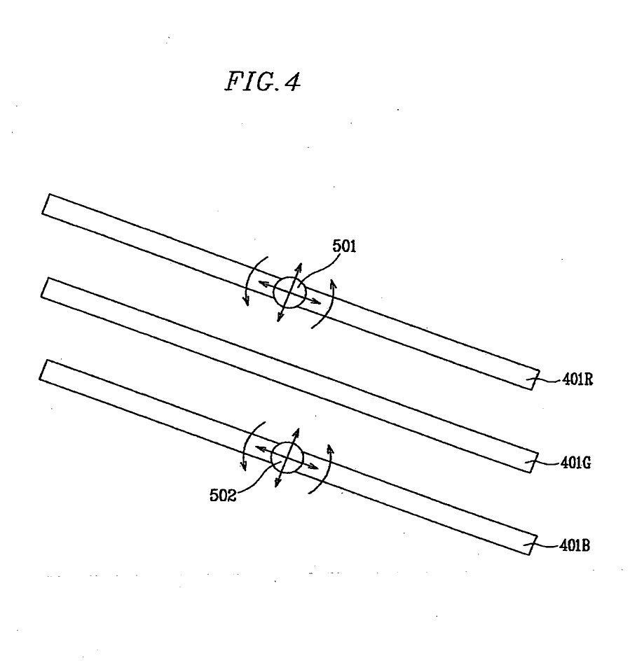

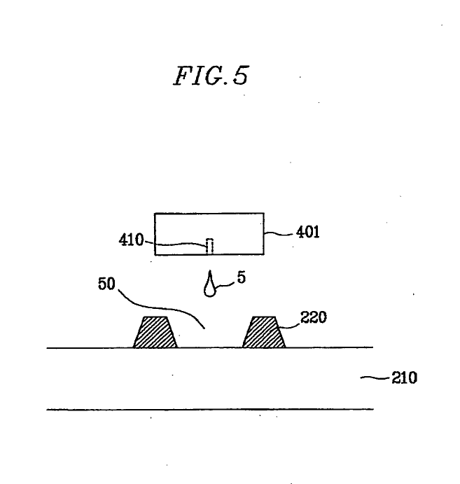

FIG. 1 is a perspective view of an ink jet printing system including a plurality of inkjet head units 401-404 disposed over a substrate 210, and FIG. 2 is a plan view illustrating a process to form color filters using an inkjet head 401. FIG. 3 is a perspective view of inkjet head unit 401, and FIG. 4 is a plan view of inkjet head unit 401. FIG. 5 shows a process to dispense ink on a substrate using inkjet head 401 and form color filters.

Referring to FIG. 1, an inkjet printing system includes a stage 100, substrate 210, and a plurality of inkjet head units 401, 402, 403, and 404. Each inkjet head unit moves in an X-direction over the substrate 210 on stage 100. The substrate 210 includes color filters 230 between light blocking members 220.

Referring to FIGS. 2 and 3, inkjet head unit 401 includes inkjet heads 401R, 401G, and 401B. Three of inkjet heads 401R, 401G, and 401B dispense red, green, and blue ink, respectively. The lower surface of bar-shaped inkjet heads 401R, 401G, and 401B includes a plurality of nozzles 410R, 410G, and 410B, respectively. Inkjet heads 401 can be shapes other than bar-shaped.

As shown in FIG. 3, ink jet head unit 401 includes a pair of alignment axles 501 and 502 in the center of inkjet heads 401R and 401B.

Referring to FIG. 2, inkjet heads 401R, 401G, and 401B are spaced apart from each other at an equal distance and inclined at an angle Θ with respect to a Y-direction. Because a distance D between nozzles 410 is generally different from a pitch P between color filters 230, inkjet head 410 is rotated to be inclined at an angle Θ with respect to a Y direction, so that the distance D corresponds to the pitch P.

As shown in FIGS. 2-4, inkjet head 401G is fixed as a standard point and alignment axles 501 and 502 are coupled with inkjet heads 401R and 401B, respectively. Alignment axles 501 and 502, which are connected to moving parts (not shown), move the corresponding inkjet heads in the X direction, Y direction, and rotationally to align inkjet heads 401R and 401G separately with respect to inkjet head 401G. For example, a gap Y1 between nozzles 401G and 401R can coincide with a gap Y2 between nozzles 401G and 401B by moving alignment axles 501 and 502 accordingly. Thus, alignment errors can be decreased by connecting alignment axles to the inkjet heads, thereby enabling ink to be dispensed at an equal vertical distance in a column of color filters 230 (FIG. 2).

Referring to FIGS. 1, 2, and 5, a method of forming color filters is described. Inkjet head units 401-404 are disposed over substrate 210 on stage 100 of the inkjet printing system. Nozzles 410 are moved using alignment axels 501 and 502, as discussed above, so that nozzles 410 are properly aligned in the Y-direction with respect to openings or apertures 50 between light blocking members 220. Inkjet head units 401-404 move in an X direction and dispense ink 5 toward the substrate so that nozzle 401 places ink on the aperture 50. Ink 5 in the aperture 50 dries to form color filter 230.

Because inkjet heads 401R, 401G, and 401B of inkjet head unit 401 of FIG. 3 dispense red, green, and blue ink, respectively, red, green, and blue color filters can be formed at the same time by scanning inkjet head unit 401 over the substrate 210. If desired, color filters of the same color can be formed separately, such as by only dispensing ink or moving inkjet heads of a single color.

As shown in FIG. 1, a plurality of inkjet head units 401-404 are installed in the inkjet printing system and can move simultaneously to form concurrently all color filters 230 in a Y direction. In another example, one inkjet head unit scans in the X direction to form color filters located in the X direction corresponding to nozzles 410 of inkjet head unit 401, and inkjet head unit 401 moves in a Y direction to form color filters in the Y direction. This operation is repeated to complete all of color filters 230.

Conventionally, after using inkjet head units 401-404 for a relatively long time, the nozzles 410 of the inkjet head can become contaminated and cause defects of in the pattern (e.g., color filter pattern) formed by using the inkjet printing system. This can result in poor quality or defective color filters. To reduce this problem, the present invention provides an inkjet head cleaning system for keeping and maintaining inkjet heads clean.

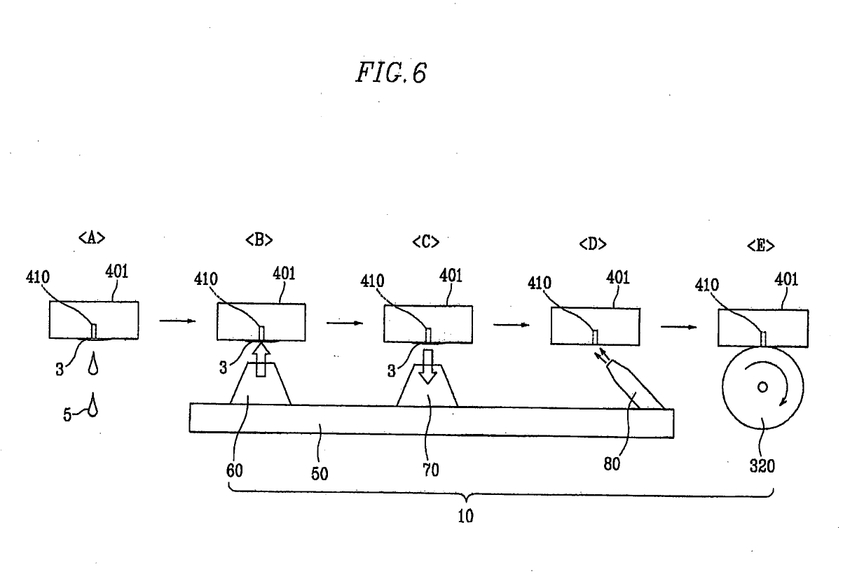

FIG. 6 shows an inkjet head cleaning system 10 according to an embodiment of the present invention.

Inkjet head cleaning system 10 includes a solvent shower 60, a suction apparatus 70, an air blower 80, and a roll brushing apparatus 90. Solvent shower 60, suction apparatus 70, and air blower 80 can be installed on a same frame 50 or each on a separate frame (not shown).

Solvent shower 60 sprays a solvent toward the lower surface of inkjet head 401, especially around nozzle 410 of inkjet head 401, to dissolve contaminants 3 that may be present in or around nozzle 410.

Suction apparatus 70, which is apart from solvent shower 60, sucks in and removes dissolved contaminants 3. During vacuuming, suction apparatus 70 may also suck in or remove solvent from inkjet head 401. Suction apparatus 70 may be a small vacuum or other suitable vacuum device, which may also include a directional nozzle to confine the air to a small pathway between nozzle 410 and suction apparatus 70.

Air blower 80, which is apart from suction apparatus 70, blows air toward the lower surface of inkjet head 401 to dry any remaining solvent from inkjet head 401.

Roll brushing apparatus 90 rotates a brush 320 on the lower surface of inkjet head 410 to mechanically remove contaminants. The mechanical removal by roll brushing apparatus 90 is useful to remove hardened and solid contaminants. Roll brushing apparatus 90 may be a circular or cylindrical brush rotatable by a motorized or powered hub. The characteristics of the brush, such as the density, type, hardness, and length of the bristles, depends on various factors, such as the hardness and size of the hardened contaminants, the speed of rotation of the brush, and the material of the inkjet head surface.

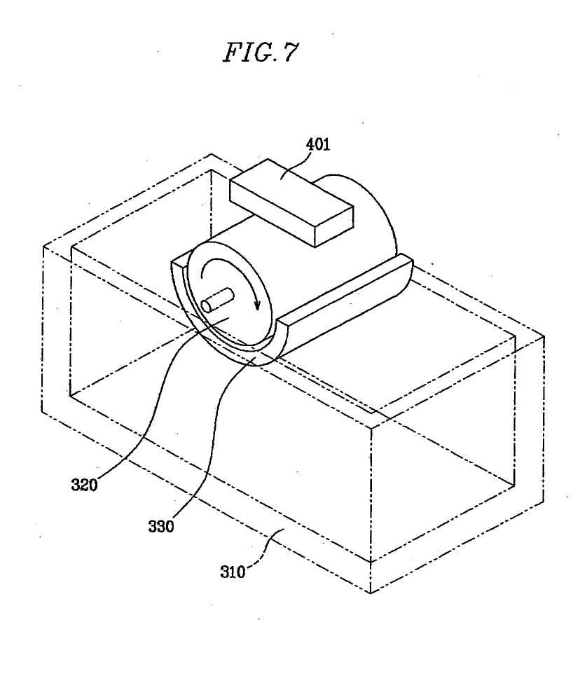

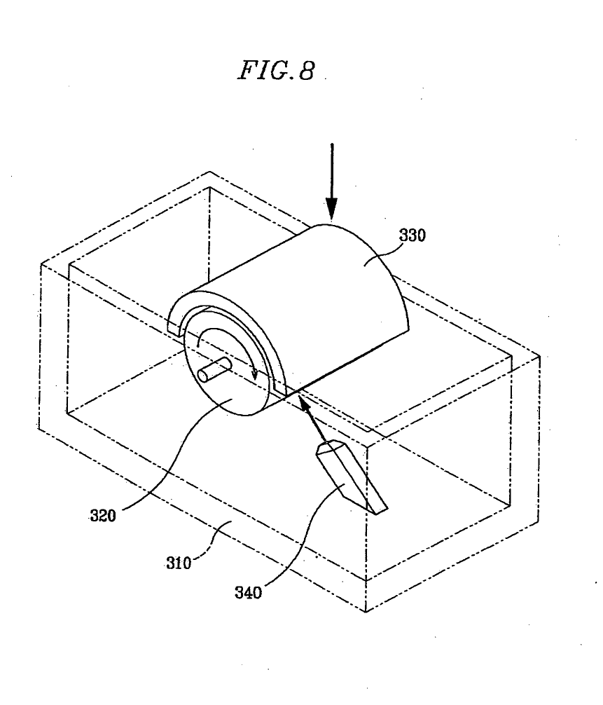

FIGS. 7 and 8 show the roll brushing apparatus with a roll brush cover 330 in different embodiments. FIG. 7 shows roll brushing apparatus 90 cleaning the lower surface of inkjet head 401 with a roll brush 320. FIG. 8 shows roll brushing apparatus 90 being dispensed with solvent to clean roll brush 320.

Referring to FIGS. 7 and 8, roll brushing apparatus 90 includes a rectangular-shaped case 310, roll brush 320 having an axle connected to case 310 to enable roll brush 320 to rotate, and roll brush cover 330 encompassing a portion of roll brush 320. Roll brush 320 is partially disposed within case 310. In one embodiment, roll brush cover 330 surrounds approximately half of the circumference of roll brush 320. Roll brush 320 rotates to clean contaminants from the lower surface of inkjet head 401. As a result, contaminants 3 (FIG. 6) can accumulate on and in roll brush 320.

When roll brush 320 rotates at a high speed to clean the lower surface of inkjet head 401, contaminants 3 on roll brush 320 can bounce or dislodge from roll brush 320 due to the centrifugal force of the rotation. This can contaminate the area around inkjet head 401. Contaminants on roll brush 320 increase as cleaning time increases. Accordingly, secondary contamination caused by the centrifugal force of roll brush 320 increases.

To reduce this problem, this present invention decreases the revolutions per minute (RPM) of roll brush 320 and provides roll brush cover 330 encompassing a portion of roll brush 320. In one embodiment, roll brush 320 rotates less than 50 RPM to clean the lower surface of inkjet head 401. The low rotational speed reduces the centrifugal force of the rotating roll brush, resulting in reduced or elimination of contaminants dislodging from roll brush 320. Roll brush cover 330 is located under roll brush 320 (i.e., located opposite inkjet head 401) when roll brush 320 cleans inkjet head 401, as shown in FIG. 7.

As shown in FIG. 8, after roll brush 320 finishes cleaning the lower surface of inkjet head 401, roll brush cover 330 is rotated approximately 180° to cover the upper portion of roll brush 320, i.e., roll brush cover 330 is between roll brush 320 and the lower surface of inkjet head 401. Roll brush 320 increases its rotation, e.g., more than 50 RPM, after cleaning inkjet head 401. The high rotational speed of roll brush 320 increases the centrifugal force and enables contaminants to come off roll brush 320, thereby cleaning roll brush 320. Because roll brush cover 330 is between the roll brush and the inkjet head, roll brush cover 330 prevents contaminants from contaminating the inkjet head.

While the roll brush rotates at an increased speed, a solvent supplier 340 located under case 310 dispenses solvent toward roll brush 320 at an angle. Solvent supplier 340 is located on the bottom of case 310 and is offset from the axle of roll brush 320. The solvent is selected to dissolve the contaminants. Thus, the solvent, in combination with the increased rotation of the roll brush, improves the cleaning efficiency of the roll brush.

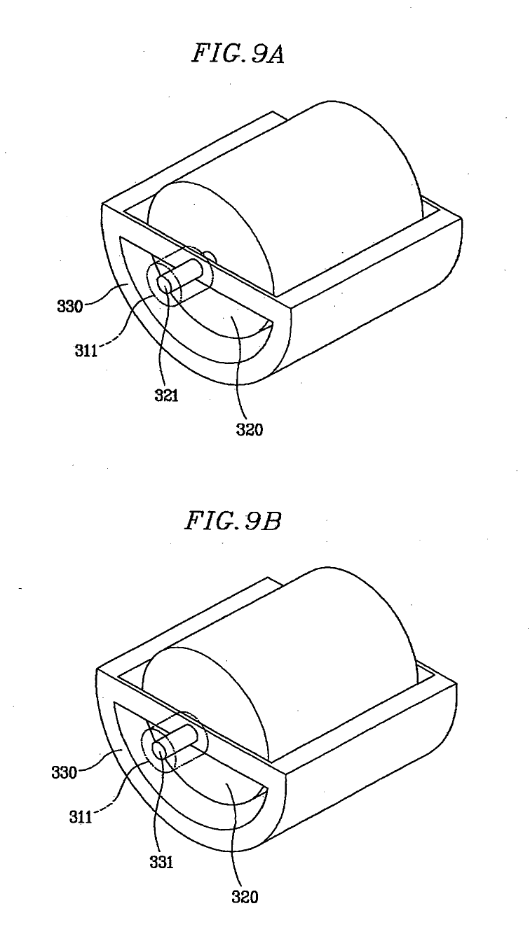

FIGS. 9A and 9B show a roll brush 320 and a roll cover 330 each having an axle to rotate roll brush 320 and roll cover 330, respectively. FIG. 9A is a front view and FIG. 9B is a back view.

Referring to FIG. 9A, a brush axle 321 is coupled to the front side of roll brush 320 through roll cover 330 to rotate roll brush 320. Referring to FIG. 9B, a cover axle 331 is coupled to the rear side of roll cover 330 to rotate roll cover 330. Brush axle 321 and cover axle 331 may be coupled to individual motors to control the rotation of the brush and axle independently.

An outer axle 311 is connected to roll brush 320 and roll cover 330, while encompassing the outer surface of brush axle 321 and cover axle 331. Outer axle 311 is coupled to an air pressure piston (not shown) to move up and down roll brush 320 and roll cover 330, where outer axle 311 may be positioned in a vertical groove to control the upward and downward movement. Other mechanisms for moving the roll brush and cover may also be suitable, such as with a mechanical or electrical movement.

Referring to FIG. 6, a cleaning method using the inkjet head cleaning system 10 is described below according to an embodiment of the present invention.

At <A>, ink in inkjet head 401 is discharged to remove ink from inside the nozzles of inkjet head 401. The discharge can be with conventional methods, such as simply turning inkjet head 401 so that the nozzles face down and removing any barriers holding in the ink.

At <B>, in one embodiment, inkjet head 401 is placed over solvent shower 60 as close to solvent shower 60 as possible to maximize the amount and force of the solvent spray to inkjet head 401. For example, if solvent shower 60 allows 0.5 mm of minimum distance, the distance is no less than 0.5 mm. The distance can be changed depending on various factors, such as shower pressure and the type of shower stream. Shower pressure can increase for longer distances between inkjet head 401 and solvent shower 60. In one embodiment, shower pressure is no more than 0.2 bar because higher pressures can contaminate neighboring areas of inkjet head 401. As inkjet head 401 is moved over solvent shower 60, solvent shower 60 sprays a solvent toward the lower surface of inkjet head 401 to dissolve contaminants 7 on the surface and especially in and around nozzle 410. In one embodiment, the solvent includes Propyl Glycol Methyl Ether Acetate (PGMEA). The solvent can be various types depending factors such as on ink composition. In another exemplary embodiment, solvent shower 60 can be a bath type, such that a nozzle of ink jet head 401 can be immersed into solvent in the bath.

At <C>, inkjet head 401 is moved over suction apparatus 70. Inkjet head 401 moves close to suction apparatus 70 to clean inside of the nozzles of inkjet head 401. Suction apparatus 70 sucks and removes the dissolved contaminants 7 through a hole or a plurality of holes. The process may also remove some or all of the solvent. Suction ability depends on various factors, such as the diameter of the holes, the distance from the inkjet head, the speed at which the inkjet head moves, and the size of the nozzles. Smaller diameter of the holes for suction apparatus 70 improves suction ability even though suction pressure is low relatively. In one embodiment, the diameter is no more than 3.0 mm.

At <D>, inkjet head 401 is moved over air blower 80. Air blower 80 blows air or other gas to dry any remaining solvent. In one embodiment, air blower 80 directs air an angle with respect to the lower surface of inkjet head 401. FIG. 6 shows an approximately 45 degree angle, although other angles may also be suitable, as well as being parallel to the nozzle. The angle of air blower 80 need not be fixed, but rather can be variable with the movement of the inkjet head. Air pressure is controlled so not to contaminate areas other than where the air is blown. Air pressure depends on various factors, such as the diameter of air outlets of air blower 80, the distance to the inkjet head, the speed at which the inkjet head passes, and the size of the nozzles. In one embodiment, air pressure is no more than 0.2 bar, and the diameter of air blower 80 is no more than 3.0 mm.

At <E>, inkjet head 401 moves over roll brushing apparatus 90, and the lower surface of inkjet head 401 comes into contact with roll brush 320 of roll brushing apparatus 90. Roll brush 320 rotates at a reduced speed, such as less than 50 RPM, to mechanically remove hard and/or solid contaminants, which may have resulted from contaminants hardening over time.

After completing the cleaning of the lower surface of inkjet head 401, roll brush 320 moves away from inkjet head 401 and roll brush cover 330 rotates approximately 180 degrees to cover the upper portion of roll brush 320. The rotational speed of roll brush 320 is then increased, e.g., more than 50 RPM, to remove contaminants on roll brush 320. Solvent is sprayed onto roll brush 320 at an angle by solvent supplier 340 to increase the efficiency of the contaminant removal.

Accordingly, roll brush cover 330 prevents contaminants coming off roll brush 320 from contaminating inkjet head 401. Solvent supplier 340 disposed inside case 310 dissolves contaminants on the roll brush to increase cleaning efficiency.

According to an embodiment of the present invention, an inkjet head cleaning system and a method for the cleaning inkjet head removes contaminants without damage to the inkjet head by using solvent to first dissolve contaminants on the inkjet head. Also, a roll brushing apparatus mechanically removes hard and solid contaminants, which may remain on the inkjet head after using the solvent. A roll brush cover encompassing a roll brush of the roll brushing apparatus prevents secondary contamination from contaminants coming off of the roll brush.

Although the invention has been described with reference to particular embodiments, the description is an example of the invention's application and should not be taken as a limitation. Various adaptations and combinations of the features of the embodiments disclosed are within the scope of the invention as defined by the following claims.

What is claimed is:

1. A roll brushing apparatus for cleaning an inkjet head comprising:
a case;
a roll brush having an axle coupled to the case to clean a lower surface of the inkjet head; and
a rotatable roll brush cover encompassing a portion of the roll brush.

2. The roll brush apparatus of claim 1, wherein the roll brush cover is disposed between the roll brush and the bottom of the case during cleaning of the lower surface of the inkjet head.

3. The roll brush apparatus of claim 1, wherein the roll cover is disposed between the roll brush and the inkjet head after cleaning the lower surface of the inkjet head.

4. The roll brush apparatus of claim 1, wherein the roll brush rotates less than 50 RPM during cleaning the lower surface of the inkjet head and rotates more than 50 RPM during a self-cleaning of the roll brush.

5. The roll brush apparatus of claim 1, further comprising a solvent supplier located inside the case under the roll brush.

6. The roll brush apparatus of claim 5, wherein the solvent supplier dispenses solvent toward the roll brush at an angle relative to the bottom of the case.

7. The roll brush apparatus of claim 1, wherein the roll brush cover surrounds half of the circumference of the roll brush.

8. The roll brush apparatus of claim 1, wherein the roll brush cover moves along the circumference of the roll brush.

9. An inkjet head cleaning system comprising:
a shower adapted to spray a solvent onto a lower surface of an inkjet head for dissolving contaminants on the inkjet head;
a vacuum spaced apart from the shower adapted to suck the dissolved contaminants from the inkjet head;
a blower spaced apart from the vacuum adapted to blow air toward the lower surface of the inkjet head; and
a roll brushing apparatus including a case, a roll brush having an axle coupled to the case and moveable to clean the lower surface of the inkjet head, and a rotatable roll brush cover encompassing a portion of the roll brush.

10. The inkjet head cleaning system of claim 9, wherein the roll brush cover is disposed between the inkjet head and the bottom of the cover during cleaning of the lower surface of the inkjet head.

11. The inkjet head cleaning system of claim 9, wherein the roll brush cover is disposed between the roll brush and the inkjet head after cleaning the lower surface of the inkjet head.

12. The inkjet head cleaning system of claim 9, wherein the roll brush rotates less than 50 RPM during cleaning of the lower surface of the inkjet head and rotates more than 50 RPM during a self-cleaning of the roll brush.

13. The inkjet head cleaning system of claim 9, further comprising a solvent supplier disposed inside the case under the roll brush.

14. The inkjet head cleaning system of claim 13, wherein the solvent supplier dispenses solvent toward the roll brush at an angle relative to the bottom of the case.

15. The inkjet head cleaning system of claim 9, wherein the roll brush cover encompasses half of the circumference of the roll brush.

16. The inkjet head cleaning system of claim 9, wherein the roll brush cover moves along the roll brush.

17. A method of cleaning an inkjet head comprising:
discharging ink from the inkjet head;
spraying a solvent toward a lower surface of the inkjet head to dissolve contaminants on the lower surface;
sucking the dissolved contaminants from the inkjet head;
blowing air toward to the lower surface of the inkjet head;
brushing the lower surface of the inkjet head with a roll brush to remove contaminants;
moving the roll brush away from the inkjet head; and
moving a roll brush cover between the roll brush and the inkjet head.

18. The method of claim 17, further comprising rotating the roll brush at more than 50 RPM during a self-cleaning process of the inkjet head.

19. The method of claim 18, further comprising dispensing a solvent into the roll brush.

20. The method of claim 17, further comprises rotating the roll brush at less than 50 RPM during cleaning of the inkjet head.

21. The method of claim 19, wherein the solvent is dispensed at an angle offset from the rotational axis of the roll brush.

22. A method of cleaning an inkjet head, comprising:
discharging ink from the inkjet head;
spraying a solvent toward a lower surface of the inkjet head to dissolve contaminants on the lower surface;
sucking the dissolved contaminants from the inkjet head;
blowing air toward to the lower surface of the inkjet head;
moving a roll brush to contact the lower surface of the inkjet head; and
rotating the roll brush less than approximately 50 RPM to remove contaminants from the inkjet head.

23. The method of claim 22, further comprising moving the roll brush away from the inkjet head and moving a roll brush cover between the roll brush and the inkjet head.

24. The method of claim 23, further comprising rotating the roll brush more than approximately 50 RPM to clean contaminants from the roll brush.

25. The method of claim 23, further comprising spraying a solvent into the roll brush to dissolve the contaminants.

26. The method of claim 25, wherein the solvent is sprayed at an angle offset from the rotational axis of the roll brush.
